(19) United States
(12) Patent Application Publication
(10) Pub. No.: US 2017/0078337 A1
(43) Pub. Date: Mar. 16, 2017

(54) SYSTEM, SERVER AND METHOD OF ENABLING AT LEAST ONE VIEWER OF PRIMARY DIGITAL CONTENT BEING BROADCAST ACROSS A COMMUNICATIONS NETWORK TO INTERACT WITH A PROVIDER OF SAID PRIMARY DIGITAL CONTENT IN REAL TIME

(71) Applicant: IPOWOW! USA INC., Los Angeles, CA (US)

(72) Inventors: Gavin DOUGLAS, Venice, CA (US); Colin HORNETT, Venice, CA (US)

(73) Assignee: IPOWOW! USA INC., Los Angeles, CA (US)

(21) Appl. No.: 15/264,247

(22) Filed: Sep. 13, 2016

Related U.S. Application Data
(60) Provisional application No. 62/218,495, filed on Sep. 14, 2015.

(51) Int. Cl. H04L 29/06; H04L 29/08

(52) U.S. Cl. CPC H04L 65/1069; H04L 65/604; H04L 67/26; H04L 67/306; H04N 21/4532

(57) ABSTRACT

A method of enabling a viewer of primary digital content being broadcast across a communications network to interact with a provider of said primary digital content in real time. The method comprises (a) receiving a request, via the communications network, to establish a communications link between a user device of the viewer and the provider of the primary digital content; and (b) establishing the communications link between the user device of the viewer and the provider according to the request. As a result, this method allows (i) secondary digital content to be pushed by the provider to the user device of the viewer via the communications link in real time for displaying thereon, and (ii) the viewer to interact directly with the provider of the secondary digital content via the communications link in real time in response to the secondary digital content received.

### RELATED APPLICATION

This application claims the benefit of U.S. Provisional Application No. 62/218,495, filed Sep. 14, 2015, which is incorporated herein by reference.

### TECHNICAL FIELD

The present disclosure relates to a system, server and method of enabling at least one viewer of primary digital content being broadcast across a communications network to interact with a provider of said primary digital content in real time.

### BACKGROUND

The following discussion of the background to the disclosure is intended to facilitate an understanding of thereof. However, it should be appreciated that the discussion is not an acknowledgement or admission that any of the material referred to was published, known or part of the common general knowledge in Australia or any other country as at the priority date of any one of the claims of this specification.

The ability of content providers to keep an audience engaged in the digital content being broadcast on, for example, television, is difficult at best, particularly, when the digital content being broadcast has been paused due to a natural break in the event or show being shown, such as for example, a half or quarter time break in a sports event. Oftentimes, the secondary digital content that is then broadcast during such breaks either involves discussions about what has transpired during the sport event being shown or is simply in the form of advertisements, typically of the sponsors sponsoring the sports event. Such secondary digital content may not be of sufficient interest to the viewers to maintain them as a captive audience. Such lapses in interest can often lead to viewers engaging in alternative activities before the start of the next quarter or half of the sports events. For example, viewers may turn away from their television set to go and make a drink and/or snack, or they may simply switch the television channel to another channel for the interim period to seek out other digital content that may be of more interest to the viewer. Ultimately, a viewer's attention being diverted away from the secondary digital content (for example, advertisements) being broadcast during a break in a sports event or show could lead to a potential loss of revenue for any content provider whose advertisements are no longer being viewed by the audience.

Attempts to make secondary digital content such as advertisements more interesting to viewers is difficult, as what interests some, does not necessarily interest others. Indeed, any attempt to improve the quality of advertisements is likely to incur a huge increase in expenditure, which may not be a cost effective solution for the content provider.

The present disclosure seeks to provide a system, server and method of enabling at least one viewer of primary digital content being broadcast across a communications network to interact with a provider of said primary digital content in real time, which will overcome or substantially ameliorate at least some of the deficiencies of the prior art, or to at least provide an alternative.

### SUMMARY

According to a first aspect of the present disclosure, there is provided a method of enabling at least one viewer of primary digital content being broadcast across a communications network to interact with a provider of said primary digital content in real time, the method comprising the steps of: receiving a request, via the communications network, to establish a communications link between a user device of the at least one viewer and the provider of the primary digital content; and establishing the communications link between the user device of the at least one viewer and the provider according to the request to allow: (i) secondary digital content to be pushed by the provider to the user device of the at least one viewer via the communications link in real time for displaying thereon, and (ii) the at least one viewer to interact directly with the provider of the secondary digital content via the communications link in real time in response to the secondary digital content received.

The method may further comprise, before step b), the steps of: extracting, from the request, identification data indicative of the at least one viewer; and verifying, via at least one database connection, the identity of the at least one viewer as a registered viewer in accordance with the identification data.

The method may further comprise the steps of: receiving, via at least one database connection, a profile of the at least one registered viewer; and selecting, based on the viewer profile, secondary digital content for pushing to the user device of the at least one registered viewer via the communications link in real time.

The viewer profile may comprise data inferred by the provider from a history of the primary digital content broadcast across the communications network that has been viewed by the registered viewer.

The viewer profile may comprise data declared by the registered viewer and/or inferred by the provider at the time of the registered viewer submitting the request to establish the communications link between the user device of the at least one viewer and the provider of the primary digital content.

The declared and/or inferred data may comprise data selected from the group consisting of: interests, email address, name, age, location, gender, demographic, income and education.

The method may further comprise, before step a), the step of: displaying a user interface on a user device of the at least one viewer, said user interface comprising at least one link to allow the at least one viewer to submit a request, via the communications network, to establish a communications link between the user device and the provider of the primary digital content.

The method may further comprise the step of: displaying a user interface on the user device of the at least one viewer, said user interface comprising at least one link to allow the secondary digital content to be sent, via the communications network, to one or more recipients upon activation of the at least one link by the at least one viewer.

The method may further comprise the steps of: displaying a user interface on the user device of the at least one viewer, said user interface comprising at least one entry field to allow the at least one viewer to input data, via the communications link, in response to a request for information associated with the secondary digital content; receiving, via the communications link, the data input by the at least one viewer; and displaying, via the user interface on the user device of the at least one viewer, an outcome based on a comparison of the input data and the requested information.

The requested information may comprise at least one question, the method further comprising the steps of: selecting, from a database adapted for storing answer data in association with the requested information, answer data in accordance with the requested information; and comparing the input data and the answer data to determine a match, wherein the outcome displayed is positive when a match exists.

The at least one viewer may be a plurality of viewers, and wherein the requested information comprises a poll, the method further comprising the step of: calculating a percentage of the input data received from the plurality of viewers in response to the poll based on the number of inputs received, wherein the outcome displayed is indicative of the percentage.

The secondary digital content may comprise audio, video, text, images, or any combination thereof.

The secondary digital content may comprise an advertisement and/or offer selected based on the viewer profile of the registered viewer.

The method further may comprise the steps of: receiving location data indicative of the location of the user device of the at least one viewer; and selecting, via at least one database connection, secondary digital content in accordance with the location data.

According to a second aspect of the present disclosure, there is provided a server for enabling at least one viewer of primary digital content being broadcast across a communications network to interact with a provider of said primary digital content in real time, the server comprising: a processor for processing digital data; a memory device for storing digital data including computer program code and being coupled to the processor; and a data network interface for sending and receiving digital data, including request data, the data interface network being communicable with the processor, in use, wherein the processor is controlled by the computer program code to: a) receive, via the data network interface, request data to establish a communications link between a user device of the at least one viewer and the provider of the primary digital content; b) establish, via the data network interface, the communications link between the user device of the at least one viewer and the provider according to the request data to allow: (i) secondary digital content to be pushed by the provider to the user device of the at least one viewer via the communications link in real time for displaying thereon, and (ii) the at least one viewer to interact directly with the provider of the secondary digital content via the communications link in real time in response to the secondary digital content received.

Before step b), the processor may be controlled by the computer program code to: extract, from the request data, identification data indicative of the at least one viewer; and verify, via at least one database connection, the identity of the at least one viewer as a registered viewer in accordance with the identification data.

The, the processor may be further controlled by the computer program code to: receive, via at least one database connection, a profile of the at least one registered viewer; and select, based on the viewer profile, secondary digital content for pushing to the user device of the at least one registered viewer via the communications link in real time.

Before step a), the processor may be controlled by the computer program code to: display a user interface on a user device of the at least one viewer, said user interface comprising at least one link to allow the at least one viewer to submit a request, via the communications network, to establish a communications link between the user device and the provider of the primary digital content.

The processor may be further controlled by the computer program code to: display a user interface on the user device of the at least one viewer, said user interface comprising at least one link to allow the secondary digital content to be sent, via the communications network, to one or more recipients upon activation of the at least one link by the at least one viewer.

The processor may be further controlled by the computer program code to: display a user interface on the user device of the at least one viewer, said user interface comprising at least one entry field to allow the at least one viewer to input data, via the communications link, in response to a request for information associated with the secondary digital content; receive, via the communications link, the data input by the at least one viewer; and display, via the user interface on the user device of the at least one viewer, an outcome based on a comparison of the input data and the requested information.

The processor may be further controlled by the computer program code to: select, from a database adapted for storing answer data in association with the requested information, answer data in accordance with the requested information; and compare the input data and the answer data to determine a match, wherein the outcome displayed is positive when a match exists.

The at least one viewer may be a plurality of viewers, and the requested information comprises a poll, the processor is further controlled by the computer program code to: calculate a percentage of the input data received from the plurality of viewers in response to the poll based on the number of inputs received, wherein the outcome displayed is indicative of the percentage.

The processor may be further controlled by the computer program code to: receive location data indicative of the location of the user device of the at least one viewer; and select, via at least one database connection, secondary digital content in accordance with the location data.

According to a third aspect of the present disclosure, there is provided a computer readable storage medium for enabling at least one viewer of primary digital content being broadcast across a communications network to interact with a provider of said primary digital content in real time, the computer readable storage medium comprising computer program code instructions recorded thereon, the computer program code instructions being executable by a computer and comprising instructions for: receiving, via a data network interface, request data indicative of a request to establish a communications link between a user device of the at least one viewer and the provider of the primary digital content; and establishing, via the data network interface, the communications link between the user device of the at least one viewer and the provider according to the request data to allow: (i) secondary digital content to be pushed by the provider to the user device of the at least one viewer via the communications link in real time for displaying thereon, and (ii) the at least one viewer to interact directly with the provider of the secondary digital content via the communications link in real time in response to the secondary digital content received.

According to a fourth aspect of the present disclosure, there is provided a client computing device for enabling at least one viewer of primary digital content being broadcast across a communications network to interact with a provider of said primary digital content in real time, the client computing device comprising: a processor for processing digital data; a memory device for storing digital data including computer program code and being coupled to the processor; and a data network interface for sending and receiving digital data, wherein the processor is controlled by the computer program code to: receive, via the data network interface, request data indicative of a request to establish a communications link between a user device of the at least one viewer and the provider of the primary digital content; establish, via the data network interface, the communications link between the user device of the at least one viewer and the provider according to the request data to allow: (i) secondary digital content to be pushed by the provider to the user device of the at least one viewer via the communications link in real time for displaying thereon, and (ii) the at least one viewer to interact directly with the provider of the secondary digital content via the communications link in real time in response to the secondary digital content received.

Other aspects of the disclosure are also disclosed.

### BRIEF DESCRIPTION OF DRAWINGS

Notwithstanding any other forms which may fall within the scope of the present disclosure, embodiments thereof will now be described, by way of example only, with reference to the accompanying drawings in which:

FIG. 1 shows a computing device on which the various embodiments described herein may be implemented in accordance with an embodiment of the present disclosure;

FIG. 2 shows a network system of computing devices on which the various embodiments described herein may be implemented in accordance with an embodiment of the present disclosure;

FIG. 3 shows a system for enabling at least one viewer of primary digital content being broadcast across a communications network to interact with a provider of said primary digital content in real time in accordance with an embodiment of the present disclosure;

FIG. 4 show steps of a method for enabling at least one viewer of primary digital content being broadcast across a communications network to interact with a provider of said primary digital content in real time in accordance with an embodiment of the present disclosure;

FIG. 5 shows a schematic representation of at least one viewer of primary digital content being broadcast across a communications network, being able to view secondary digital content on a client computing device in real time in accordance with an embodiment of the present disclosure; and

FIGS. 6 to 13 show exemplary graphical user interfaces for enabling at least one viewer of primary digital content being broadcast across a communications network to interact with a provider of said primary digital content in real time in accordance with a preferred embodiment of the present disclosure.

### DETAILED DESCRIPTION OF SPECIFIC EMBODIMENTS

It should be noted in the following description that like or the same reference numerals in different embodiments denote the same or similar features. Although specific embodiment are described herein, the invention is not limited thereto, and extends to the principles described and suggested by the applicant herein and equivalents thereof.

### General Computing Device

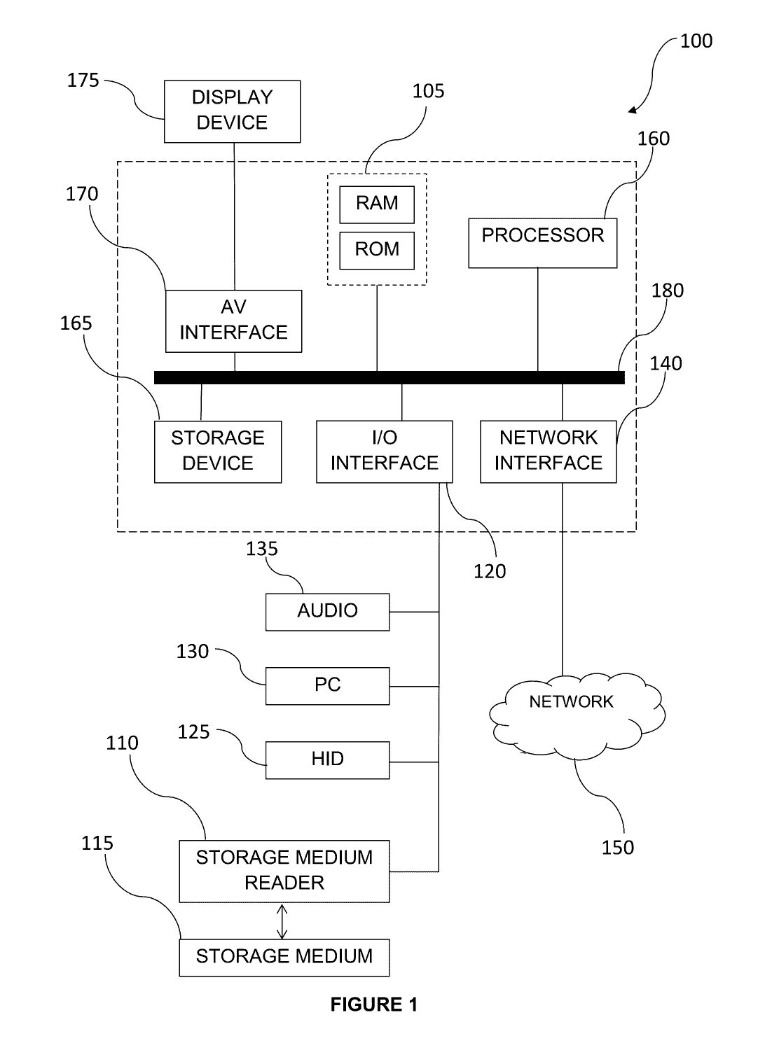

FIG. 1 shows a general computing device 100 on which the various embodiments described herein may be implemented. In particular the steps of a method 300 for enabling at least one viewer of primary digital content being broadcast across a communications network to interact with a provider of said primary digital content in real time may be implemented as computer program code instructions executable by such a computing device 100. In a typical arrangement, the computer program code instructions may be divided into one or more computer program code instruction libraries, such as dynamic link libraries (DLL), wherein each of the libraries performs one or more steps of the method 300. Additionally, a subset of the one or more of the libraries may perform graphical user interface tasks relating to the steps of the method 300.

The computing device 100 comprises a memory device for storing digital data including computer program code. The memory device is provided in the form of semiconductor memory 105 comprising volatile memory such as random access memory (RAM) or read only memory (ROM). The memory 105 may comprise either RAM or ROM or a combination of RAM and ROM.

The computing device 100 comprises a computer program code storage medium reader 110 for reading the computer program code instructions from computer program code storage media 115. The storage media 115 may be optical media such as CD-ROM disks, magnetic media such as floppy disks and tape cassettes or flash media such as USB memory sticks.

The computing device 100 further comprises an I/O interface 120 for communicating with one or more peripheral devices. The I/O interface 120 may offer both serial and parallel interface connectivity. For example, the I/O interface 120 may comprise a Small Computer System Interface (SCSI), Universal Serial Bus (USB) or similar I/O interface for interfacing with the storage medium reader 110. The I/O interface 120 may also communicate with one or more human input devices (HID) 125 such as keyboards, pointing devices, joysticks and the like. The I/O interface 120 may also comprise a computer to computer interface, such as a Recommended Standard 232 (RS-232) interface, for interfacing the device 100 with one or more personal computer (PC) devices 130. The I/O interface 120 may also comprise an audio interface for communicate audio signals to one or more audio devices 135, such as a speaker or a buzzer.

The computing device 100 also comprises a data network interface 140 for communicating with one or more computer networks 150 to send and receive digital data. The network 150 may be a wired network, such as a wired Ethernet™ network or a wireless network, such as a Bluetooth™ network or IEEE 802.11 network. The network 150 may be a local area network (LAN), such as a home or office computer network, or a wide area network (WAN), such as the Internet 230 or private WAN.

The computing device 100 comprises an arithmetic logic unit or processor 160 that is coupled to the semiconductor memory 105, and is configured for performing the computer program code instructions and processing the digital data. The processor 160 may be a reduced instruction set computer (RISC) or complex instruction set computer (CISC) processor or the like. The computing device 100 further comprises a storage device 165, such as a magnetic disk hard drive or a solid state disk drive.

Computer program code instructions may be loaded into the storage device 165 from the storage media 115 using the storage medium reader 110 or from the network 150 using the data network interface 140. During the bootstrap phase, an operating system and one or more software applications are loaded from the storage device 165 into the memory 105. During the fetch-decode-execute cycle, the processor 160 fetches computer program code instructions from memory 105, decodes the instructions into machine code, executes the instructions and stores one or more intermediate results in memory 105.

In this manner, the instructions stored in the memory 105, when retrieved and executed by the processor 160, may configure the computing device 100 as a special-purpose machine that may perform the functions described herein.

The computing device 100 also comprises a video interface 170 for conveying video signals to a display device 175, such as a liquid crystal display (LCD), cathode-ray tube (CRT) or similar display device.

The computing device 100 also comprises a communication bus subsystem 180 for interconnecting the various devices described above. The bus subsystem 180 may offer parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like.

### System

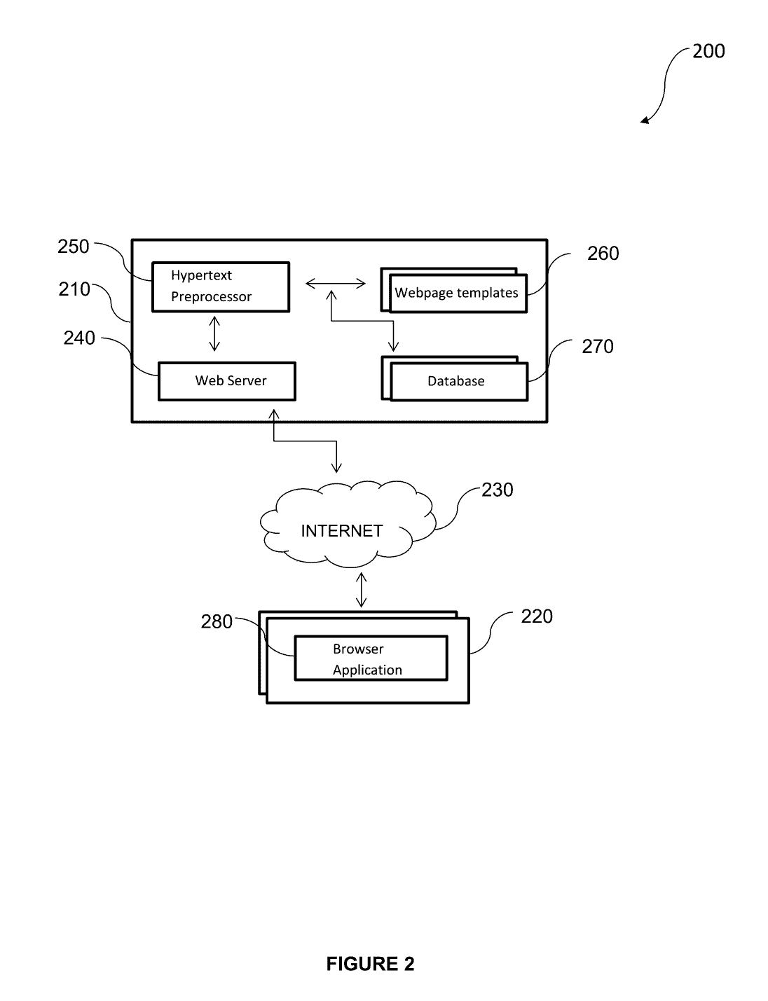

In a preferred embodiment, the embodiments described herein are implemented across the Internet web architecture. As such, FIG. 2 shows a network system 200 of computing devices 100 on which the various embodiments described herein may be implemented. The network system 200 comprises a webserver 210 for serving web pages to one or more client computing devices 220 running a browser application 280 over the Internet 230.

### Server

As will become apparent from the disclosure herein, the webserver 210 may be adapted for several tasks, including transmitting secondary digital content to the client computing devices 220, extracting and verifying identification data to verify the identity of a viewer as a registered viewer, and the like.

For the purposes of defining the scope of embodiments of the present disclosure, it will be understood that the provider of the primary digital content being broadcast over the network 150 has direct access to the server 210 in order to generate and/or compile the secondary digital content for pushing to the viewers in real time.

The server 210 comprises the basic components described above for the general computing device 100 (see FIG. 1), namely, the processor 160 for processing digital data, the semiconductor memory 105 for storing digital data including computer program code, and a data network interface 140 for sending and receiving digital data, and being communicable with the processor 160. The server 210 further comprises a database connection with a database 270 for storing digital data.

In one embodiment, the database 270 is a Microsoft SQL server.

The database 270 may comprise digital data relating not only to the secondary digital content that may be compiled by the provider for pushing to the user devices of the viewers, but also to the viewers themselves. For instance, the database 270 may comprise digital date relating to identification data associated with a number of viewers registered with the system 200, viewer profile data of the registered viewers created from information declared by the registered viewers and/or information about the registered viewers inferred by the provider from other information known about the viewers, as well as secondary digital content in the form of audio, video, text, images, or any combination thereof, that may have been compiled by the provider in readiness for pushing to the client computing devices 220 of the viewers in real time at the next break in broadcasting of the primary digital content.

### Audio Data Format

The audio data may be formatted in accordance with a wide variety of audio formats. Examples of such audio formats may be mp3, aiff, aac, ALAC, amr, flac, m4a, ogg, wma, and way. It should be appreciated that the list of audio formats is not exhaustive, and may be expanded or narrowed in other embodiments, depending on implementation.

### Image Data Format

The image data may be formatted in accordance with a wide variety of image formats. Examples of such image formats may be jpeg, jpeg-variant, exif, tiff, raw, gif, bmp, and png. Of course, the list of image formats is not exhaustive, and may be expanded or narrowed in other embodiments, according to need.

It should be noted that the image data may be construed as comprising video data, since the process of displaying video information can be construed as the process of displaying a plurality of image frames in a predetermined manner, sometimes with corresponding synchronised audio data.

### Video Data Format

The pre-recorded video data may be formatted in accordance with a wide variety of video formats. Examples of such video formats may be .flv, .avi, .mov, .mp4, .mpg, .wmv, .3gp, .asf, .rm and .swf formats. Of course, the list of video formats is not exhaustive, and may be expanded or narrowed in other embodiments, according to need.

### Transcoding of Secondary Digital Content Data

Due to the wide variety of client computing devices 220 and format standards available in the market, sometimes compatibility can be an issue. For example, if the client computing device 220 is incompatible with one or both of the audio data and image data, transcoding may be needed. The server 210 may, in one embodiment, be configured to transcode the audio data and/or the image data into a compatible format so as to ensure compatibility with the client computing device 220.

In one embodiment, the server 210 may be configured to actively transcode the secondary digital content prior to sending to the client computing device 220 in accordance with registration information acquired about the client computing device 220. Such registration information may be obtained and maintained by the server 210 upon, for example, establishment of communication link with the client computing device 220. In another embodiment, the server 210 may be configured to passively transcode the secondary digital content upon receipt of notification of incompatibility from the client computing device 220.

Several transcoding means may be adopted. For example, a transcoder device may be operably coupled to the processor 160 and the database 270, such that the server 210 may control the transcoder device for transcoding the secondary digital content in the database 270 as needed. Such transcoding may be performed in real time prior to sending the secondary digital content to the client computing device 220. Alternatively, such transcoding may be performed at an earlier time, prior to receiving request data from one or more viewers to establish a communications link with the provider such that different formats of the same secondary digital content can be stored in the database 270 for selective serving to a corresponding client computing device 220 upon request.

It will be appreciated by persons skilled in the relevant art that transcoding of the secondary digital content should not be construed as being limited to the above description, and may take on any other suitable arrangement.

It will be appreciated that the server 210 is not limited to simply accessing just one database 270 via the database connection to retrieve and store such digital data. For example, the server 210 may be configured to retrieve digital data stored on more than one database. In one such arrangement, one or more databases 270a may be configured to store digital data relating to the viewers, and one or more other databases 270b may be configured to store secondary digital content. For the purpose of defining the relationship between the server 210 and the database 270, the description will refer to just one database 270 for storing digital data relating to the viewers and digital data related to the secondary digital content.

Referring to FIG. 2, it will be understood that in the case of a web server 210, such a server is provided with a web server application 240 for receiving requests, such as Hypertext Transfer Protocol (HTTP) and File Transfer Protocol (FTP) requests, and serving hypertext web pages or files in response. The web server application 240 may be, for example the Apache™ or the Microsoft™ IIS HTTP server. The web server 210 is also provided with a hypertext pre-processor 250 for processing one or more web page templates 260 and data from one or more databases 270 to generate hypertext web pages. The hypertext pre-processor may, for example, be the PHP: Hypertext Pre-processor (PHP) or Microsoft Asp™ hypertext pre-processor. The web server 210 is also provided with web page templates 260, such as one or more PHP or ASP files.

Upon receiving a request from the web server application 240, the hypertext pre-processor 250 is operable to retrieve a web page template, from the web page templates 260, execute any dynamic content therein, including updating or loading information from the one or more databases 270, to compose a hypertext web page. The composed hypertext web page may comprise client side code, such as JavaScript, for Document Object Model (DOM) manipulating, asynchronous HTTP requests and the like.

According to preferred embodiments of the present disclosure, it will be understood that the client computing devices 220 are each provided with a browser application 280, such as, for example, Mozilla Firefox™, Microsoft internet Explorer™′ Google Chrome™ or Safari™ browser applications to allow the viewers to make a request, via the Internet 230, to establish a communications link between the client computing device 220 and the server 210. It will be understood that the client computing devices 220 are adapted for receiving HTML content and the like from the webserver 210 across the Internet 230, and that the general operation of the browser application 280 involves requesting hypertext web pages from the web server 210 and rendering the hypertext webpages on a display 175 of the client computing device 220.

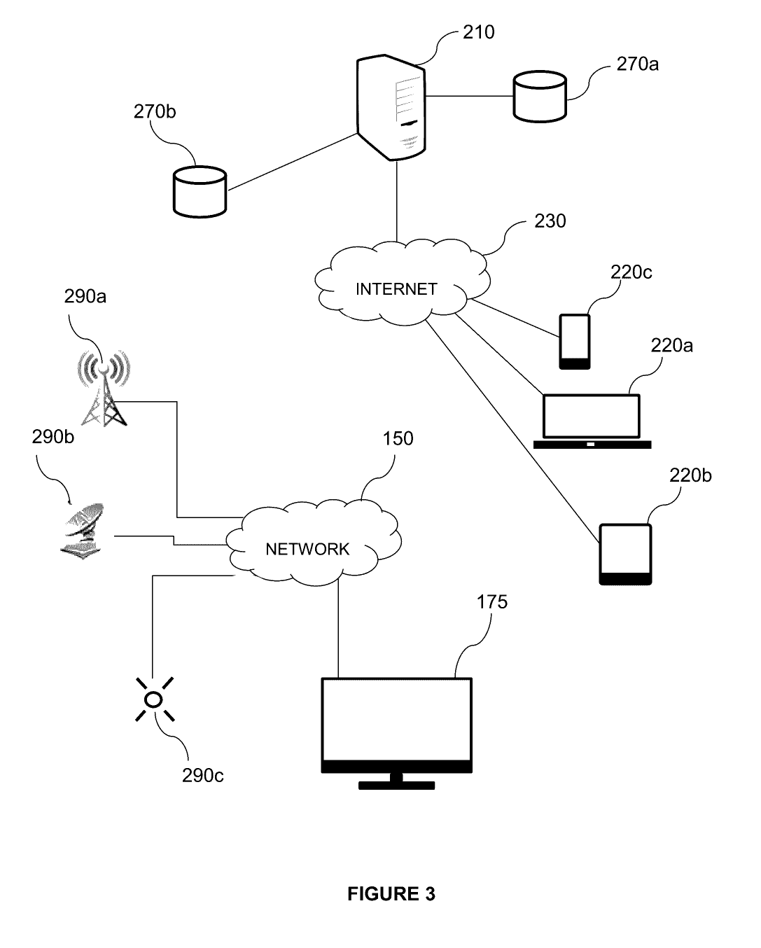

Turning now to FIG. 3, there is shown a system for enabling a viewer or viewers of primary digital content being broadcast across a network 150 to interact with the provider of said primary digital content in real time via the Internet 230.

Television transmission or distribution systems used by traditional carriers of television programming include terrestrial broadcast stations 290a, satellite television 290b, and cable television systems 290c, as well as telecom delivery network services offered over broadcast telecommunication or data networks 150. More recently, standards have been formulated for using Internet protocols and the Internet to distribute television programming using “live” IP-multicast or IP unicast streams that can be received by viewers with a broadband data connection to the Internet. For the purpose of defining the scope of preferred embodiments of the present disclosure, hereinafter, the Internet will be referred to as a network 150 where the internet is used to distribute or stream primary digital content to the viewer. In all other cases, particularly where a communications link has been established between the provider and the viewer to allow secondary digital content to be pushed to the viewer and for the viewer to interact with the provider, the Internet will be referred to as the Internet 230.

In a preferred embodiment, the present disclosure will be described with reference to the following environment in which viewers are able to view the primary digital content being broadcast by the provider, namely a television network, via one or more of the transmission/distribution systems described above. Thus, in the case of a live sports event, it will be appreciated that the primary digital content being broadcast corresponds to the sports event taking place, and this content is simply viewed by viewers on a television or monitor 175 at their respective homes. Televisions may take the form of a smart television that is configured to receive and decode a signal corresponding to the primary digital content that is being broadcast via a broadcast station 290a or transmitted/distributed by a television carrier via a cable 290c or satellite system 290b. Alternatively, televisions may comprise a set top box or some other gateway or device (not shown) that receives and decodes the signal so that the primary digital content can then be viewed on the television 175.

It will be appreciated that the present disclosure is not limited to this particular viewing arrangement. For instance, in other embodiments, the primary digital content being broadcast over the network 150 may be viewed by viewers either on a large monitor in the actual venue at which the sports event is taking place, or on a television or monitor operating within a public venue such as a theatre, bar, restaurant or the like.

### Provider Computing Device

In a preferred embodiment of the present disclosure, the provider has direct access to the server 210 to be able to generate and compile the secondary digital content for pushing to the client computing devices 220 of those viewers registered to receive the secondary digital content. In this arrangement, it will be understood that one or more display devices 175 will be operably connected to the server 210 to allow the provider to compile the secondary digital content retrieved from the one or more databases 270a, 270b and/or the Internet 230.

### Client Computing Device

The client computing device 220 comprises the basic components described above for the general computing device 100 (see FIG. 1). The client computing device 220 may take the form of, for example, a personal computer, a laptop computer 220a, a personal digital assistant (PDA), a tablet computer 220b, a smart phone 220c, or a wearable computer such as a smart watch.

It will be appreciated that the client computing device 220 may comprise any one or more forms of input means, including a physical or virtual keyboard, a touch pad, a touch screen, a computer mouse, a trackball, a stylus, and even a microphone and a speech recognition engine configured to recognize a voice command by the viewer over the microphone, hereinafter termed as voice recognition.

In a preferred embodiment, the client computing device 220 takes the form of either a laptop computer 220a, a smart phone 220c or a tablet computer 220b, having one or more of the following input means including a virtual keyboard, a stylus, and/or voice recognition capability. For the purposes of defining the scope of the preferred embodiment, the laptop computer 220a, the smart phone 220c or the tablet computer 220b will collectively be referred to, hereinafter, as a mobile client computing device 220.

It will be appreciated that the mobile client computing device 220 may typically comprise a cellular interface, which is configured for 2G, 3G, or 4G cellular communications, and/or a Wi-Fi or Bluetooth™ interface, to enable the mobile client computing device 220 to connect to a wireless local area network (WLAN) resource such as the Internet 230 via a wireless network access point 4.0 or hotspot.

Mobile client computing devices 220 may be used in the manners described herein in for transmitting to the server 210 (a) request data via the Internet 230 to establish a communications link with the provider of the primary digital content being broadcast over the network 150, and (b) input data in response to a request by the provider for information associated with the secondary digital content.

The mobile client computing device 220 will be able to receive secondary digital content from the server 210 and transmit other forms of data, such as identification data, to the server 210 upon a communications link being established between the mobile client computing device 220 and the server 210.

### Mobile Location

The mobile client computing device 220 may also be used for transmitting location data to the server 210 that is indicative of the location of the viewer operating the mobile client computing device 220. Such location data may be obtained via multilateration of radio signals between (several) cell towers of the network 150 and the mobile client computing device 220, in which the location of the mobile client computing device 220 can be determined based on signal strength relating to the distance between the mobile client computing device 220 relative to the cell towers. It may also be possible to obtain location data by virtue of cell identification over a cellular network, which is also based on signal strengths relating to the distance between the mobile client computing device 220 relative to base stations or other mobile devices 220 equipped with the same capability. A further example relies on Wi-Fi which is again based on the signal strengths relating to the distance between the mobile client computing device 220 and one or more wireless network access points 4.0 or hotspots. Alternatively, the mobile client computing device 220 may comprise a Global Positioning System (GPS) transceiver, in which case, the precise location coordinates of the mobile client computing device 220 can be determined based on triangulation techniques relative to a number of orbiting satellites.

### Fixed Location

It will be appreciated by those skilled in the relevant art, that in embodiments in which the client computing device 220 is not a mobile device, but rather a device in a fixed location such as a personal computer, the location data of the client computing device 220 can be obtained from the local IP address.

### Method

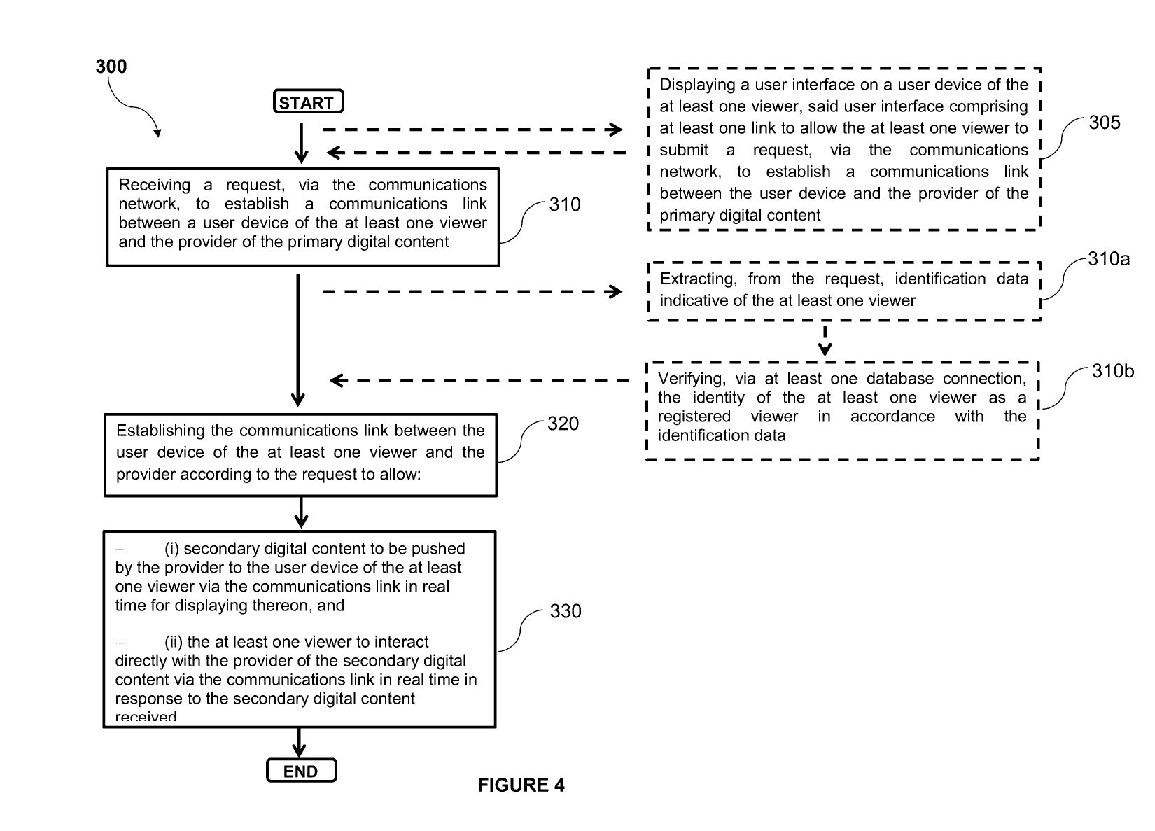

FIG. 4 shows a method 300 for enabling a viewer or viewers of primary digital content being broadcast across a network 150 to interact with the provider of said primary digital content over the Internet 230 in real time via their mobile client computing device 220.

The method 300 is executed by the server 210, to push secondary digital content to the mobile client computing devices 220 of those viewers by virtue of a direct communications link being established between the server 210 and the mobile client computing devices 220 over the Internet 230.

As shown in FIG. 4, the method 300 starts at step 310, where the provider receives at the server 210, via the data network interface 140, request data sent from the mobile client computing device 220 of a viewer over the Internet 230. Typically, the viewer will be directed to the provider's webpage to make the request. For example, the webpage may have been advertised during broadcasting of the primary digital content over the network 150, or advertised at the start of a break in the event being broadcast.

In a preferred form, the webpage comprises a user interface for displaying on the mobile client computing device 220 according to step 305. The user interface shows a login page, which comprises at least one hyperlink to enable the viewer to submit the request, which once pressed, will instruct the server 210 to establish a communications link between the mobile client computing device 220 and the server 210.

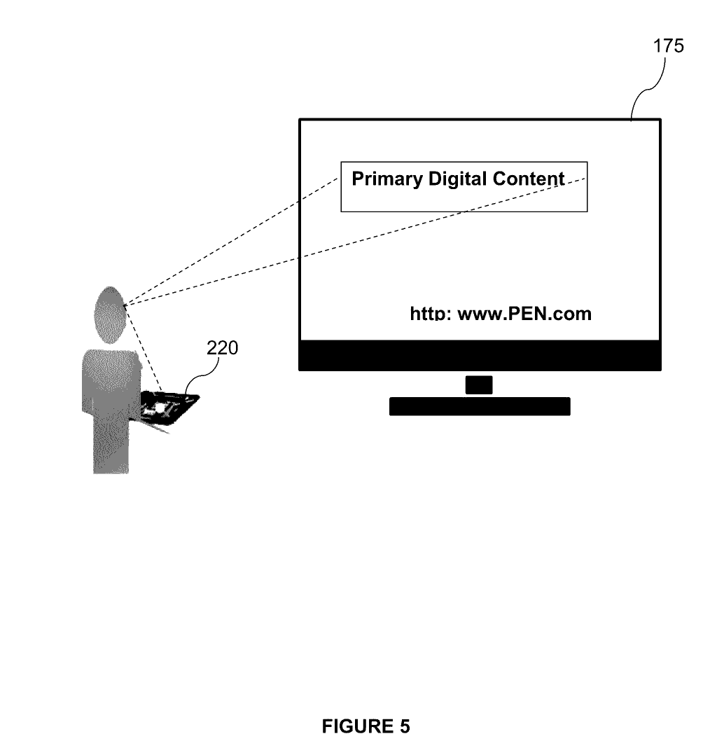

FIG. 5 shows a typical scenario according to a preferred embodiment of the present disclosure in which, once a viewer has accessed the webpage of the provider by entering the advertised webpage link “http:www.PEN.com” into the graphical user interface displayed on his or her mobile client computing device 220, a communications link is established between the server 210 and the mobile client computing device 220 and the viewer is then not only able to view the primary digital content being broadcast over the network 150 on a television 175, but is also able to receive, in real time, exclusive secondary digital content on the mobile client computing device 220 that has been generated and pushed to the mobile client computing device 220 by the provider of the primary digital content. By virtue of what is hereinafter referred to as appointment viewing, the viewer can receive exclusive secondary digital content that the viewer would otherwise not have been able to receive via any other means.

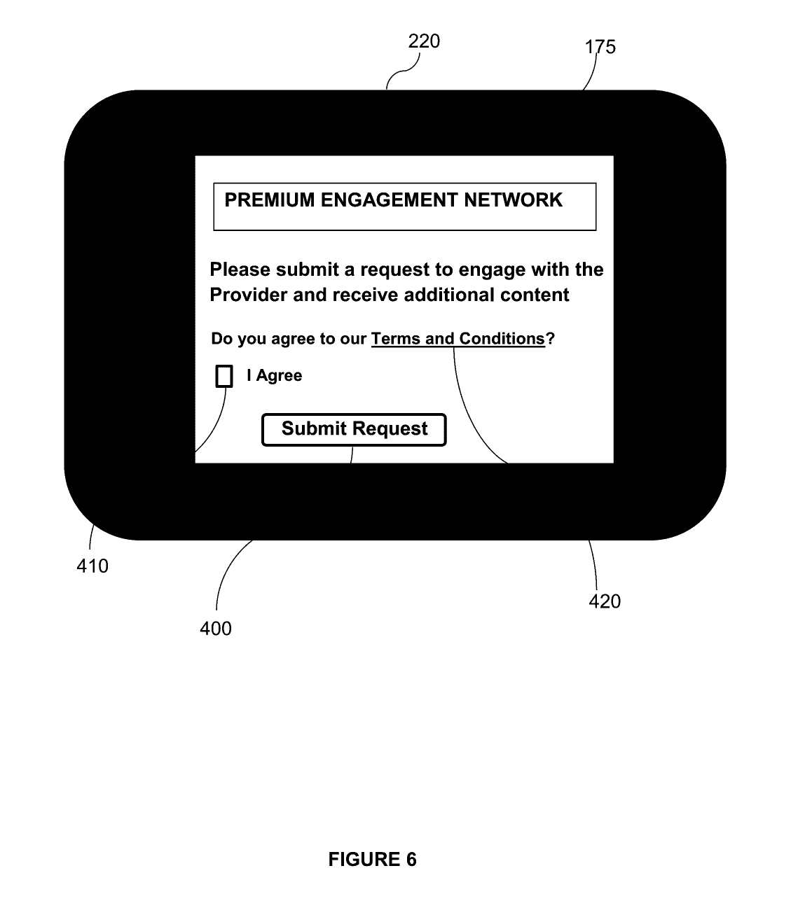

FIG. 6 shows an exemplary graphical user interface of a typical webpage that would appear on the display 175 of the mobile client computing device 220 to enable the viewer to submit the request to the provider to establish the communications link between the mobile client computing device 220 and the server 210 to access, what we have defined herein as the Premium Engagement Network (PEN). The webpage comprises HTML content detailing how the viewer can access the Premium Engagement Network, and a hyperlink 400 to allow the viewer to submit the request to establish the communications link to access the Premium Engagement Network.

As an additional step, it may be necessary for the viewer to firstly accept the terms and conditions associated with the Premium Engagement Network before the hyperlink 400 is enabled to allow the request to be submitted. The terms and conditions can be accepted by simply entering a tick in the tick box 410. It will be appreciated that the terms and conditions may be viewed by pressing a second hyperlink 420 to open up a corresponding webpage (not shown) comprising the actual terms and conditions.

Alternatively, the viewer can submit a request to the provider to establish the communications link between the mobile client computing device 220 and the server 210 to access the Premium Engagement Network by entering identification data to register the viewer.

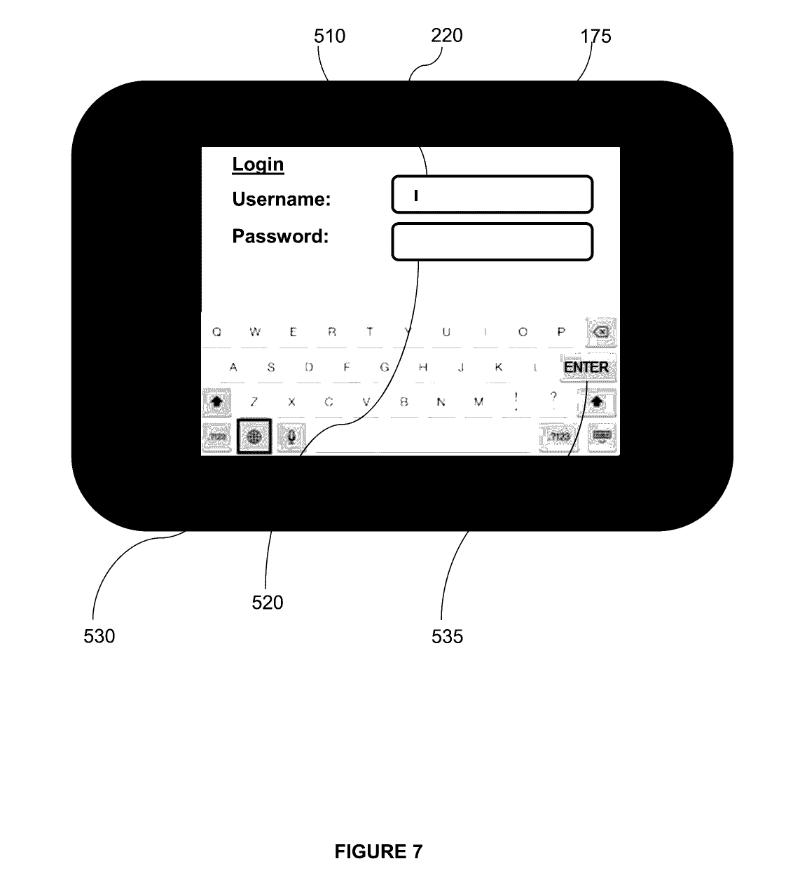

FIG. 7 shows an exemplary graphical user interface of a typical webpage that would appear on the display 175 of the mobile client computing device 220 to enable the viewer to enter identification data in the form of login details such as, for example, a username 510, which may also be an email address, and a password 520. It will be appreciated that the username 510 and the password 520 may be entered using any one of a number of input means. In this example, the input means is a virtual keyboard 530, and the request may be submitted by virtue of pressing “ENTER” 535 on the keyboard 530.

By virtue of the viewer entering identification data in this manner, the identification data can be stored on a database 210 and subsequently used to verify the identity of the viewer if he or she chooses to submit a request to establish a communications link in the future. In this respect, and as shown in FIG. 4, the method 300 comprises a further step, step 310a, of extracting the identification data indicative of the viewer.

Once the identification data has been received at the server 210, the method 300 comprises a further step 310b of crosschecking the identification data against existing viewer profile data stored on the database 270 to see whether the viewer has previously registered with the system 200.

It will be appreciated by those skilled in the relevant art that it may also be possible for the viewer to register with the system 200 via a social media account (not shown), such as a Facebook™ account, a Google+™ account, or the like. In this respect, the personally identifiable information (PII) that is associated with the social media account, and which would have been established at the time when the viewer created the social media account, can now be used to not only identify the viewer, but also used by the provider as a basis to tailor the secondary digital content to be pushed to the viewer.

It will be appreciated that once a viewer has registered with the system 200, then it is possible for a profile of the registered viewer to be created and stored on the database 270 for future reference.

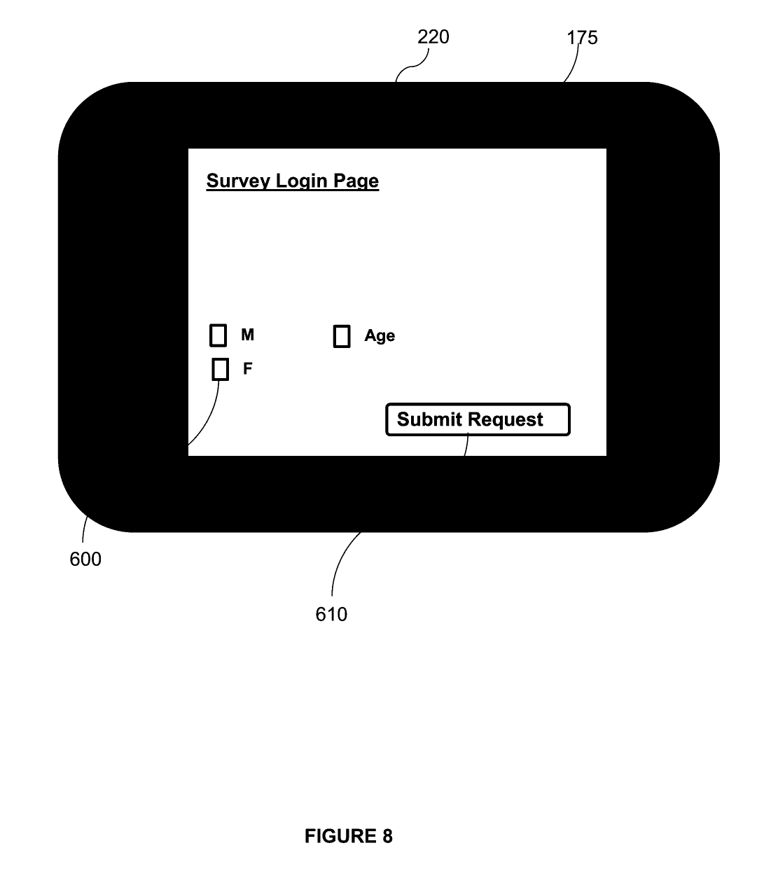

FIG. 8 shows an exemplary graphical user interface of an alternative approach by which a viewer can submit a request to establish a communications link between the server 210 and the mobile client computing device 220. Rather than entering a username and password, the viewer simply enters demographic data such as, for example, gender, age, or the like by selecting the corresponding tick box 600 and then clicking the request link 610. According to this approach, the viewer remains anonymous, but the exclusive secondary digital content that the viewer receives can be tailored by the provider according to the declared data (gender, age, and the like).

Where a viewer has previously registered to access the Premium Engagement Network, and thus a viewer profile exists on the database 270, the registered viewer can choose to receive secondary digital content even when they are not actively viewing the primary digital content being broadcast. For example, secondary digital content that may have been created by the provider based on a live sports event that is being broadcast, but not being watched by a registered viewer, may still be pushed to the mobile client computing device 220 of that registered viewer. The registered viewer may be alerted to the new secondary digital content by virtue of an audible alarm, a vibration, or a visual indicator on the display 175 of the mobile client computing device 220.

By virtue of having a viewer profile on file, it is possible for the provider to have a better understanding of the interests and preferences of the registered viewer, and to generate secondary digital content that is tailored to those interests and preferences.

The profile of the registered viewer can be retrieved from the database 270, via the database connection, and then secondary digital content can be selected by the provider according to the viewer profile for subsequently pushing to the mobile client computing device 220 of the registered viewer via the communications link in real time.

It will be appreciated that the nature of the data stored within the viewer profile may comprise a whole host of data acquired through various means. For example, such data may be inferred by the provider from a history of the primary digital content that has previously been viewed by the registered viewer. Indeed, if the registered viewer has positively interacted with the secondary digital content that has been pushed to the mobile client computing device 220 on a previous occasion, then this previous interaction may form part of the inferred data now stored on the database 270.

In addition, the viewer profile may comprise data that has been declared by the registered viewer at the time of submitting the request to establish the communications link between the mobile client computing device 220 and the server 210. For example, such declared data may take the form of declared interests and preferences, an email address or username, the name, age and gender of the viewer, as well as other demographic data, the location in which the viewer resides, obtained from the location data, as well as their occupation, income and education.

It may also be possible for the provider to infer information about the viewer at the time of submitting the request to establish the communications link between the mobile client computing device 220 and the server 210 based on the information provided by the viewer. Such inferred information may then be stored on the database 270 as inferred data for future reference.

In any case, as shown in FIG. 4, once a communications link has been established, as per step 320 of the method 300, this direct connection ensures, as shown in step 330, that (i) tailored secondary digital content can be pushed by the provider to the mobile client computing device 220 in real time, and (ii) that the viewer is then able to interact directly with the provider, via the established communications link in real time, in response to any secondary digital content received from the provider.

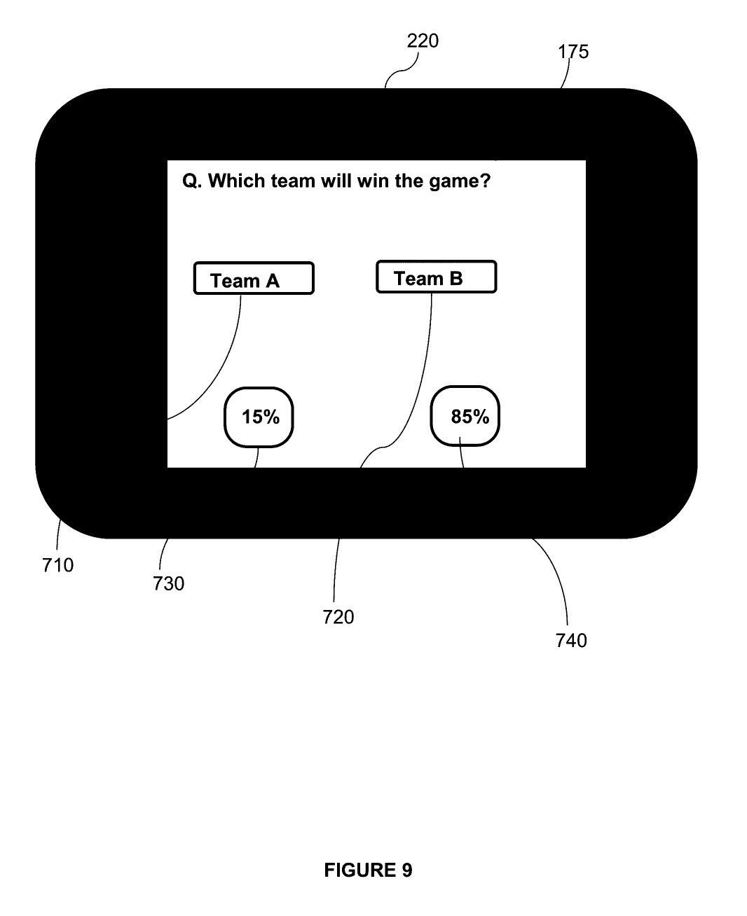

FIGS. 9 to 13 show exemplary graphical user interfaces (GUIs) of a particular example in which the viewer is able to interact with the secondary digital content provided by the provider in real time. In this example, the primary digital content being broadcast over the network 150 is an NFL football game, and the game has just entered half time. To keep the viewers engaged during the half time break, a message is displayed on the viewer's television screens 175 inviting the viewers to access the Premium Engagement Network via a webpage. The viewers submit a request to establish the communications link with the server 210, as described above (see FIGS. 4 to 8), to access the Premium Engagement Network.

Turning firstly to FIG. 9, as part of the Premium Engagement Network, the provider generates exclusive secondary digital content in the form of a question, which is pushed from the server 210 to each of the mobile client computing devices 220 in which a direct communications link has been established. The question, “Which team will win the game?” Team A or Team B, is displayed as HTML content on the display 175 of the mobile client computing device 220. The registered viewer can vote who they think will win the game by clicking on the hyperlink 710 for Team A or the hyperlink 720 for Team B. The server 210 registers each click by the registered viewers as input data, which it receives via the communications link established between the server 210 and the corresponding mobile client computing device 220. In this example, the two hyperlinks 710, 720 can be pressed any one of a number of times by each of the registered viewers on their respective mobile client computing devices 220 over a fixed time period. A global indication of how many times a particular hyperlink 710, 720 has been pressed by each of the registered viewers is indicated, in real time, on the display 175 as a percentage 730, 740, which has been calculated by the processor 160 based on the number of inputs received. It will be appreciated that the percentages 730, 740 will change, in real time, until the fixed time period ends.

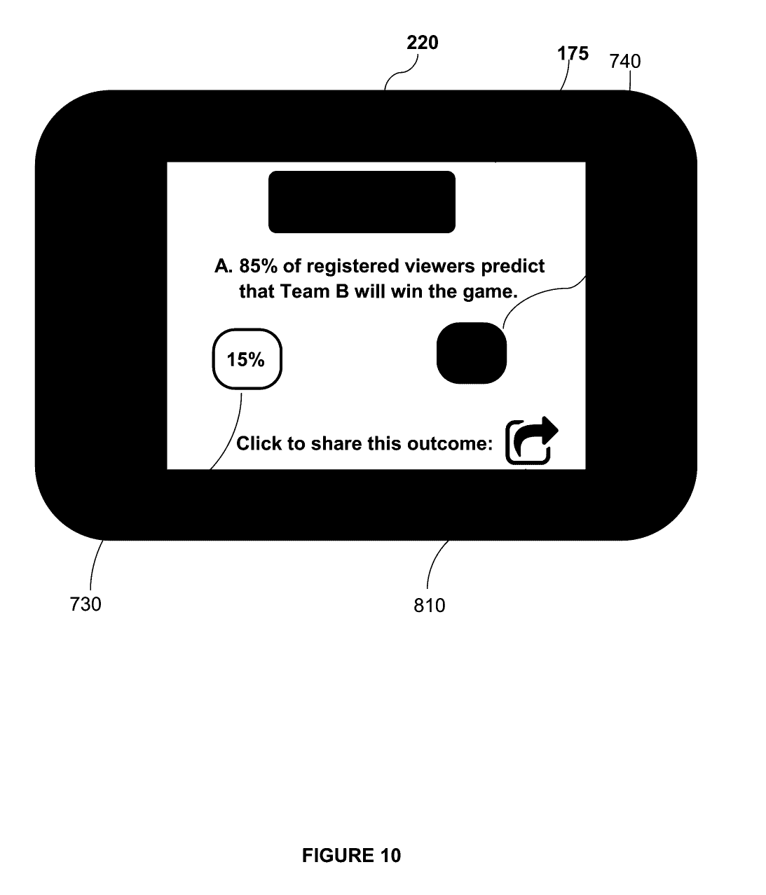

Referring now to FIG. 10, at the end of the fixed time period, the vote is closed, as indicated by the HTML content displayed at the top of the display 175. From the votes cast by the registered viewers, it is established that 85% of the registered viewers believe that Team B will win the game. The registered viewer is then presented with an option to share the outcome of this poll with one or more recipients by clicking on hyperlink 810. In one example, clicking on hyperlink 810 may forward the outcome of the poll to a media community or organization that is connected to or communicating with the system 200. Example media communities or organizations may include Facebook™, Google+™ LinkedIn™, and Twitter™, MySpace™, YouTube™, and the like. Alternatively, the hyperlink 810 may simply open up a second webpage (not shown) on the display 175 of the mobile client computing device 220 in which the registered viewer is then invited to enter the email address of a friend or friends to whom they wish to send the outcome of the poll to.

By virtue of having the option to forward/share such secondary digital content with one or more recipients, these recipients may receive exclusive digital content that they may not otherwise have received or have had the opportunity to receive via other means. This is also beneficial to the provider, as the secondary digital content, which may be in the form of an advertisement, is now capable of being viewed by others who would not normally have received the advertisement, thereby resulting in an increased likelihood of a sale.

Similarly, by being armed with the profiles of several registered viewers, providers can pre-plan an advertising campaign for a forthcoming break in the broadcasting of the primary digital content based on the number of registered viewers that are actively engaged at the time, and who share the same or similar interests or preferences.

It is appreciated that additional incentives may be employed by the provider to keep the registered viewers engaged. For example, a prize may be awarded to those registered viewers that guess the outcome correctly.

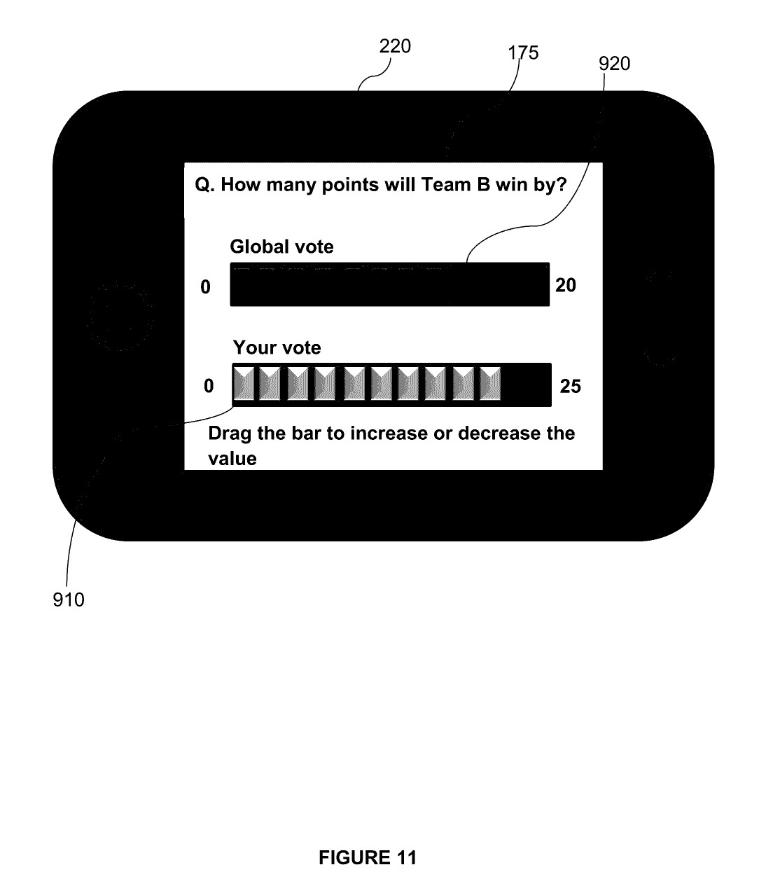

Referring to FIG. 11, the provider generates an additional question, which is pushed from the server 210 to each of the mobile client computing devices 220 in real time. The question “How many points will Team B win by?” is displayed as HTML content on the display 175 of each mobile client computing device 220.

The registered viewers are then presented with a slide bar indicator 910 at the bottom of the display 175 of their respective mobile client computing device 220, which the registered viewer can slide left or right by, for example, dragging a stylus or their finger across the display 175 in the corresponding direction, to increase or decrease the number of points they believe Team B will win by. This particular question is allowed to run over a fixed time period. As the poll proceeds, a global indication of the number of points the registered viewers believe Team B will win by is indicated by the slide bar indicator 920 in real time. For instance, as shown in FIG. 11, the registered viewer of this particular mobile client computing device 220 has indicated that Team B will win by 25 points, whereas the global indication based on a cumulative assessment of all of the input data, that is votes, presented by all of the registered viewers actively engaged in the poll, indicates that Team B will win by 20 points.

At the end of the fixed time period, the vote is closed, and the number of points predicted by each registered viewer is stored in the database 270 for future reference when the end of the NFL game is reached and a winner or winners of the poll can be announced.

At the end of the NFL game, it is established that Team B has recorded a win over Team A by 25 points. The final score from the NFL game is compared with the number of points predicted by each of the registered viewers which are stored on the database 270 to identify a winner or winners.

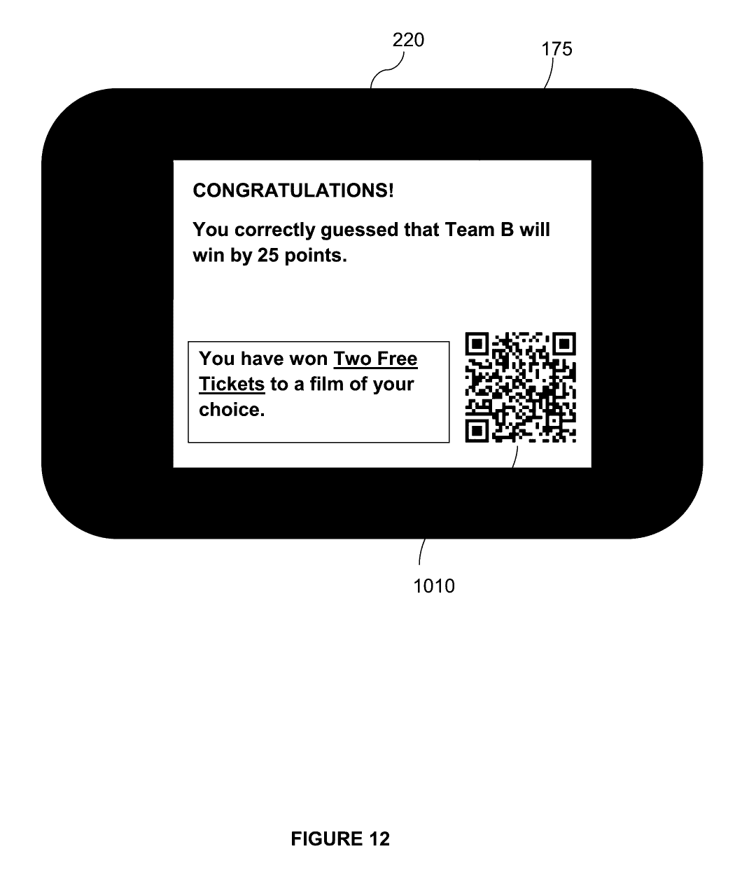

As shown in FIG. 12, the HTML content displayed on the display 175 of the mobile client computing device 220 reveals that the registered viewer of this particular mobile client computing device 220 has correctly guessed that Team B will win by 25 points. In recognition of the correct guess, the provider retrieves the registered viewer's profile from the database 270, identifies that the registered viewer is a film fanatic, and then subsequently rewards the registered viewer with a coupon in the form of a QR code 1010, which the registered viewer can redeem against the cost of two tickets to a film of their choice.

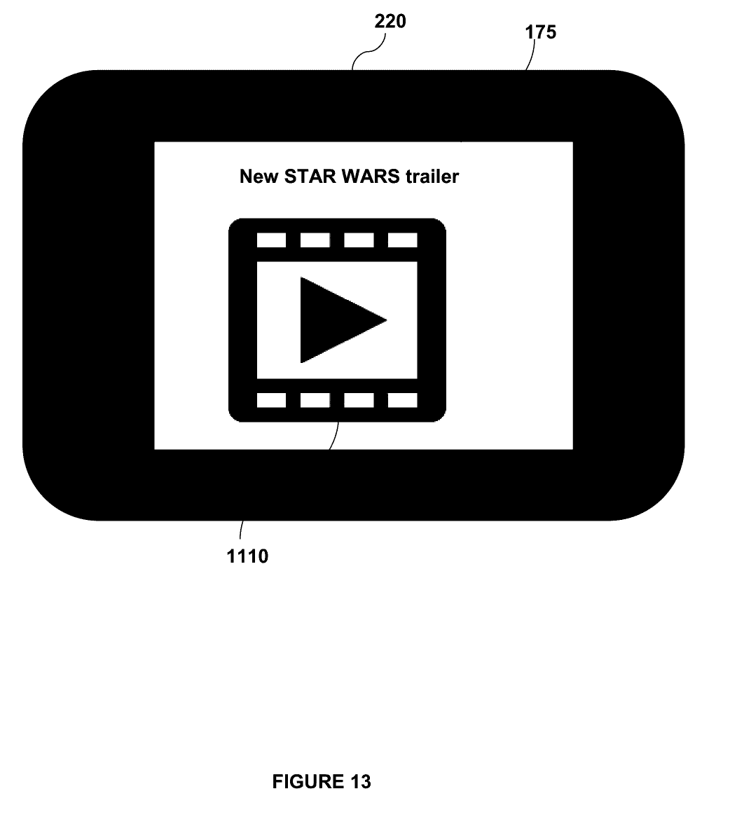

Registered viewers are not simply limited to receiving coupons as rewards, but may also receive secondary digital content from the provider that is not yet available to others. For example, turning to FIG. 13, in recognition of the registered viewer's interest in films, particularly in SciFi films, the provider can select audio, video and/or images according to this interest. For instance, in this case, a video clip 1110 of the new Star Wars™ trailer that the provider has exclusive access to, and that is not yet available from sites such as YouTube™ or the like, can be pushed to the registered viewer's mobile client computing device 220 over the Internet 230.

It will be appreciated that for other registered viewers who may have correctly guessed that Team B would win by 25 points, and were subsequently awarded two free film tickets, that the additional exclusive secondary digital content that may be pushed to their mobile client computing device 220 by the provider will be selected according their particular film preference. For example, in the case where the registered viewer has an interest in romantic comedies, then the exclusive secondary digital content pushed to that person's mobile client computing device 220 may take the form of a trailer (not shown) to a forthcoming romantic comedy.

In other embodiments, it will be understood that it is not necessary for a registered viewer to have to win or correctly answer a question in order to receive exclusive secondary digital content. For example, by virtue of a registered viewer remaining engaged with the Premium Engagement Network throughout the broadcast of the primary digital content, then secondary digital content can be pushed, in real time, to the registered viewer at one or more intervals throughout the broadcast.

In addition, by virtue of knowing the location of the registered viewer, on account of the server 210 receiving location data determined by multilateration or triangulation techniques, secondary digital content in the form of advertisements and/or offers can be more precisely tailored to the needs of the registered viewer. Indeed, by being able to tailor advertisements and/or offers according to a viewer's profile, there is an increased likelihood that the registered viewer will remain engaged during the break in the broadcasting of the primary digital content, with an increased likelihood that the advertisement/offer will be of interest to the viewer, and a sale.

In short, as a result of establishing a direct communications link between the provider of primary digital content being broadcast over a network 150 and the mobile client computing device 220 of a registered viewer, the registered viewer can, by virtue of this so-called appointment viewing, receive exclusive secondary digital content from the provider, in real time, as a reward for viewing the primary digital content.

### Other Embodiments

In other embodiments, it will be appreciated that the graphical user interface (GUI) displayed on the display 175 of the mobile client computing device 220 may comprise a webpage or form to allow the viewer to input data, via the established communications link, in response to a request by the provider for information associated with the secondary digital content. For example, the requested information may take the form of personal information such as name, age, address, interests, preferences or the like.

In another embodiment, the requested information may take the form of a question. In this respect, the response to the question that is input by the registered viewer into an entry field (not shown) displayed ion the GUI is received by the server 210 and then compared with answer data stored on the database 270 to determine a match. In the case where a positive match exists, the outcome is displayed on the display 175 of the mobile client computing device 220. Again, the registered viewer may be rewarded for a correct answer by offering a reward tailored specifically to the interests or preferences of the registered viewer.

It is to be understood that the present disclosure is not limited to the embodiments described above, but encompasses any and all embodiments within the scope of the following claims.

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps or components, or group thereof.

1. A method of enabling at least one viewer of primary digital content being broadcast across a communications network to interact with a provider of said primary digital content in real time, the method comprising the steps of:
a) receiving a request, via the communications network, to establish a communications link between a user device of the at least one viewer and the provider of the primary digital content; and
b) establishing the communications link between the user device of the at least one viewer and the provider according to the request to allow:
(i) secondary digital content to be pushed by the provider to the user device of the at least one viewer via the communications link in real time for displaying thereon, and
(ii) the at least one viewer to interact directly with the provider of the secondary digital content via the communications link in real time in response to the secondary digital content received.

2. A method according to claim 1, the method further comprising, before step b), the steps of:
extracting, from the request, identification data indicative of the at least one viewer; and
verifying, via at least one database connection, the identity of the at least one viewer as a registered viewer in accordance with the identification data.

3. A method according to claim 2, the method further comprising the steps of:
receiving, via at least one database connection, a profile of the at least one registered viewer; and
selecting, based on the viewer profile, secondary digital content for pushing to the user device of the at least one registered viewer via the communications link in real time.

4. A method according to claim 3, wherein the viewer profile comprises data inferred by the provider from a history of the primary digital content broadcast across the communications network that has been viewed by the registered viewer.

5. A method according to claim 3, wherein the viewer profile comprises data declared by the registered viewer and/or inferred by the provider at the time of the registered viewer submitting the request to establish the communications link between the user device of the at least one viewer and the provider of the primary digital content.

6. A method according to claim 5, wherein the declared and/or inferred data comprises data selected from the group consisting of: interests, email address, name, age, location, gender, demographic, income and education.

7. A method according to claim 1, the method further comprising, before step a), the step of:
displaying a user interface on a user device of the at least one viewer, said user interface comprising at least one link to allow the at least one viewer to submit a request, via the communications network, to establish a communications link between the user device and the provider of the primary digital content.

8. A method according to claim 1, the method further comprising the step of:
displaying a user interface on the user device of the at least one viewer, said user interface comprising at least one link to allow the secondary digital content to be sent, via the communications network, to one or more recipients upon activation of the at least one link by the at least one viewer.

9. A method according to claim 1, the method further comprising the steps of:
displaying a user interface on the user device of the at least one viewer, said user interface comprising at least one entry field to allow the at least one viewer to input data, via the communications link, in response to a request for information associated with the secondary digital content;
receiving, via the communications link, the data input by the at least one viewer; and
displaying, via the user interface on the user device of the at least one viewer, an outcome based on a comparison of the input data and the requested information.

10. A method according to claim 9, wherein the requested information comprises at least one question, the method further comprising the steps of:
selecting, from a database adapted for storing answer data in association with the requested information, answer data in accordance with the requested information; and
comparing the input data and the answer data to determine a match, wherein the outcome displayed is positive when a match exists.

11. A method according to claim 9, wherein the at least one viewer is a plurality of viewers, and wherein the requested information comprises a poll, the method further comprising the step of:
calculating a percentage of the input data received from the plurality of viewers in response to the poll based on the number of inputs received, wherein the outcome displayed is indicative of the percentage.

12. A method according to claim 1, wherein the secondary digital content comprises audio, video, text, images, or any combination thereof.

13. A method according to claim 1, wherein the secondary digital content comprises an advertisement and/or offer selected based on the viewer profile of the registered viewer.

14. A method according to claim 1, the method further comprising the steps of:
receiving location data indicative of the location of the user device of the at least one viewer; and
selecting, via at least one database connection, secondary digital content in accordance with the location data.

15. A server for enabling at least one viewer of primary digital content being broadcast across a communications network to interact with a provider of said primary digital content in real time, the server comprising:
a processor for processing digital data;
a memory device for storing digital data including computer program code and being coupled to the processor; and
a data network interface for sending and receiving digital data, including request data, the data interface network being communicable with the processor, in use, wherein the processor is controlled by the computer program code to:
a) receive, via the data network interface, request data to establish a communications link between a user device of the at least one viewer and the provider of the primary digital content;
b) establish, via the data network interface, the communications link between the user device of the at least one viewer and the provider according to the request data to allow:
(i) secondary digital content to be pushed by the provider to the user device of the at least one viewer via the communications link in real time for displaying thereon, and
(ii) the at least one viewer to interact directly with the provider of the secondary digital content via the communications link in real time in response to the secondary digital content received.

16. A server according to claim 15, wherein, before step b), the processor is controlled by the computer program code to:
extract, from the request data, identification data indicative of the at least one viewer; and
verify, via at least one database connection, the identity of the at least one viewer as a registered viewer in accordance with the identification data.

17. A server according to claim 15, wherein the processor is further controlled by the computer program code to: receive, via at least one database connection, a profile of the at least one registered viewer; and
select, based on the viewer profile, secondary digital content for pushing to the user device of the at least one registered viewer via the communications link in real time.

18. A server according to claim 15, wherein, before step a), the processor is controlled by the computer program code to:
display a user interface on a user device of the at least one viewer, said user interface comprising at least one link to allow the at least one viewer to submit a request, via the communications network, to establish a communications link between the user device and the provider of the primary digital content.

19. A server according to claim 15, wherein the processor is further controlled by the computer program code to:
display a user interface on the user device of the at least one viewer, said user interface comprising at least one link to allow the secondary digital content to be sent, via the communications network, to one or more recipients upon activation of the at least one link by the at least one viewer.

20. A server according to claim 15, wherein the processor is further controlled by the computer program code to:
display a user interface on the user device of the at least one viewer, said user interface comprising at least one entry field to allow the at least one viewer to input data, via the communications link, in response to a request for information associated with the secondary digital content;
receive, via the communications link, the data input by the at least one viewer; and
display, via the user interface on the user device of the at least one viewer, an outcome based on a comparison of the input data and the requested information.

21. A server according to claim 20, wherein the processor is further controlled by the computer program code to:
select, from a database adapted for storing answer data in association with the requested information, answer data in accordance with the requested information; and
compare the input data and the answer data to determine a match, wherein the outcome displayed is positive when a match exists.

22. A server according to claim 20, wherein the at least one viewer is a plurality of viewers, and wherein the requested information comprises a poll, wherein the processor is further controlled by the computer program code to:
calculate a percentage of the input data received from the plurality of viewers in response to the poll based on the number of inputs received, wherein the outcome displayed is indicative of the percentage.

23. A server according to claim 15, wherein the processor is further controlled by the computer program code to:
receive location data indicative of the location of the user device of the at least one viewer; and
select, via at least one database connection, secondary digital content in accordance with the location data.

24. A computer readable storage medium for enabling at least one viewer of primary digital content being broadcast across a communications network to interact with a provider of said primary digital content in real time, the computer readable storage medium comprising computer program code instructions recorded thereon, the computer program code instructions being executable by a computer and comprising instructions for:
a) receiving, via a data network interface, request data indicative of a request to establish a communications link between a user device of the at least one viewer and the provider of the primary digital content; and
b) establishing, via the data network interface, the communications link between the user device of the at least one viewer and the provider according to the request data to allow:
(i) secondary digital content to be pushed by the provider to the user device of the at least one viewer via the communications link in real time for displaying thereon, and
(ii) the at least one viewer to interact directly with the provider of the secondary digital content via the communications link in real time in response to the secondary digital content received.

25. A client computing device for enabling at least one viewer of primary digital content being broadcast across a communications network to interact with a provider of said primary digital content in real time, the client computing device comprising:
a processor for processing digital data;
a memory device for storing digital data including computer program code and being coupled to the processor; and
a data network interface for sending and receiving digital data, wherein the processor is controlled by the computer program code to:
a) receive, via the data network interface, request data indicative of a request to establish a communications link between a user device of the at least one viewer and the provider of the primary digital content;
b) establish, via the data network interface, the communications link between the user device of the at least one viewer and the provider according to the request data to allow:
(i) secondary digital content to be pushed by the provider to the user device of the at least one viewer via the communications link in real time for displaying thereon, and
(ii) the at least one viewer to interact directly with the provider of the secondary digital content via the communications link in real time in response to the secondary digital content received.
